(19) United States
(12) Patent Application Publication
(10) Pub. No.: US 2021/0035001 A1
(43) Pub. Date: Feb. 4, 2021

(54) CAUSATION ESTIMATION APPARATUS, CAUSATION ESTIMATION METHOD AND PROGRAM

(71) Applicant: Nippon Telegraph and Telephone Corporation, Tokyo (JP)

(72) Inventors: Yasuhiro Ikeda, Musashino-shi, Tokyo (JP); Yoichi Matsuo, Musashino-shi, Tokyo (JP); Yusuke Nakano, Musashino-shi, Tokyo (JP); Keisuke Ishibashi, Musashino-shi, Tokyo (JP); Keishiro Watanabe, Musashino-shi, Tokyo (JP); Ryoichi Kawahara, Musashino-shi, Tokyo (JP)

(21) Appl. No.: 16/970,164

(22) PCT Filed: Feb. 18, 2019
(86) PCT No.: PCT/JP2019/005857

§ 371 Date: Aug. 14, 2020

(30) Foreign Application Priority Data
Feb. 19, 2018 (JP) 2018-027408

(51) Int. Cl. G06N 7/00; G06N 3/08

(52) U.S. Cl. CPC G06N 7/005; G06N 3/084

(57) ABSTRACT

A causality estimation device includes: an input unit configured to input data of a temporally sequential multi-dimensional numerical vector; a regression model learning unit configured to learn a non-linear regression model with which data at a time is predicted from data at a past time by using the input data of the temporally sequential multi-dimensional numerical vector; a causality estimation unit configured to calculate the strength of causality of a dimension i due to a dimension j in the data of the temporally sequential multi-dimensional numerical vector by using the non-linear regression model; and an output unit configured to output the strength of the causality calculated by the causality estimation unit.

### TECHNICAL FIELD

The present invention relates to the technology of analyzing temporally sequential numerical data collected from a system and estimating the causality relation between the data. The term “causality” used in the present specification is causality based on a relation that appears on data, and is estimated from, for example, such a fact that variation is observed in data B after data A varies. The causality on data does not necessarily indicate “true causality” behind, but is thought to be sufficiently useful in understanding of system behavior and estimation of anomaly cause and thus is an estimation target in the present invention.

### BACKGROUND ART

When temporally sequential multivariate data can be obtained from a system, estimation of the inter-data causality relation based on the obtained data is important for understanding of the system behavior and clarification of the cause of anomaly occurred to the system (Non-Patent Literature 1 and Non-Patent Literature 2).

When target data is temporally sequential, in particular, causality estimation using Granger causality (Non-Patent Literature 3) or an impulse response function (Non-Patent Literature 4) based on vector autoregression (VAR) that predicts future data by using past data can be performed in small amount of time even for multi-dimensional input data. For the latter case of the impulse response function, in particular, the strength of causality can be quantitatively evaluated.

### CITATION LIST

### Non-Patent Literature

Non-Patent Literature 1: Kobayashi, Satoru, Kensuke Fukuda, and Hiroshi Esaki. “Causation mining in network logs.” ACM SIGCOMM CoNEXT 2016 Student Workshop. 2016.
Non-Patent Literature 2: Gonzalez, Jose Manuel Navarro, Javier Andion Jimenez, and Juan Carlos Duenas Lopez. “Root Cause Analysis of Network Failures Using Machine Learning and Summarization Techniques.” IEEE Communications Magazine 55.9 (2017): 126-131.
Non-Patent Literature 3: Barnett, Lionel, Adam B. Barrett, and Anil K. Seth. “Granger causality and transfer entropy are equivalent for Gaussian variables.” Physical review letters 103.23 (2009): 238701.
Non-Patent Literature 4: Pesaran, H. Hashem, and Yongcheol Shin. “Generalized impulse response analysis in linear multivariate models.” Economics letters 58.1 (1998): 17-29.
Non-Patent Literature 5: Koop, Gary, M. Hashem Pesaran, and Simon M. Potter. “Impulse response analysis in nonlinear multivariate models.” Journal of econometrics 74.1 (1996): 119-147.
Non-Patent Literature 6: Shimizu, Shohei, et al. “A linear non-Gaussian acyclic model for causal discovery.” Journal of Machine Learning Research 7. October (2006): 2003-2030.

### SUMMARY OF THE INVENTION

### Technical Problem

Typical impulse response function analysis using the VAR is based on linear regression. However, it is thought that data obtained from a system includes not only linear relations but also a large number of non-linear relations. When the data includes syslog appearance or the like, in particular, such a non-linear causality relation is thought that a syslog appears when another syslog and still another syslog simultaneously appear (AND) or when only one of them appears (OR).

Although theoretical discussion of a non-linear impulse response function is provided (Non-Patent Literature 5), no specific method of sufficiently expressing a complicate relation in system data and achieving non-linear regression that allows theoretical derivation of the impulse response function is provided in practical use.

For example, a PC algorithm (Non-Patent Literature 1) and LiNGAM (Non-Patent Literature 6), other than the impulse response function, are disclosed as methods of estimating the causality relation between multivariate data, but the PC algorithm needs an extremely large amount of calculation in a case of a close causality relation and cannot estimate the strength of causality, and the LiNGAM assumes a linear relation. Thus, it is a problem how to achieve estimation of non-linear causality in multi-dimensional data.

The present invention is intended to solve the above-described problem and provide a technology that enables estimation of a non-linear causality relation between dimensions by using temporally sequential multivariate data obtained from a system.

### Means for Solving the Problem

According to the technology of the present disclosure, provided is a causality estimation device including: an input unit configured to input data of a temporally sequential multi-dimensional numerical vector; a regression model learning unit configured to learn a non-linear regression model with which data at a time is predicted from data at a past time by using the input data of the temporally sequential multi-dimensional numerical vector; a causality estimation unit configured to calculate the strength of causality of a dimension i due to a dimension j in the data of the temporally sequential multi-dimensional numerical vector by using the non-linear regression model; and an output unit configured to output the strength of the causality calculated by the causality estimation unit.

### Effects of the Invention

According to the technology of the present disclosure, provided is a technology that enables estimation of a non-linear causality relation between dimensions by using temporally sequential multivariate data obtained from a system.

### BRIEF DESCRIPTION OF DRAWINGS

FIG. 1 is a configuration diagram of a causality estimation device 100 in an embodiment of the present invention.

FIG. 2 is a hardware configuration diagram of the causality estimation device 100.

FIG. 3 is a flowchart illustrating the procedure of processing in Example 1.

FIG. 4 is a diagram illustrating an example in which the strength of causality is calculated with combination of Examples 3 and 4.

FIG. 5 is an image of data generated through simulation.

FIG. 6 is a diagram illustrating a result of accuracy evaluation with N=100 in the simulation.

FIG. 7 is a diagram illustrating a result of accuracy evaluation with N=500 in the simulation.

### DESCRIPTION OF EMBODIMENTS

The following describes an embodiment of the present invention (the present embodiment) with reference to the accompanying drawings. The embodiment described below is merely exemplary, and an embodiment to which the present invention is applied is not limited to the embodiment below.

(System Configuration)

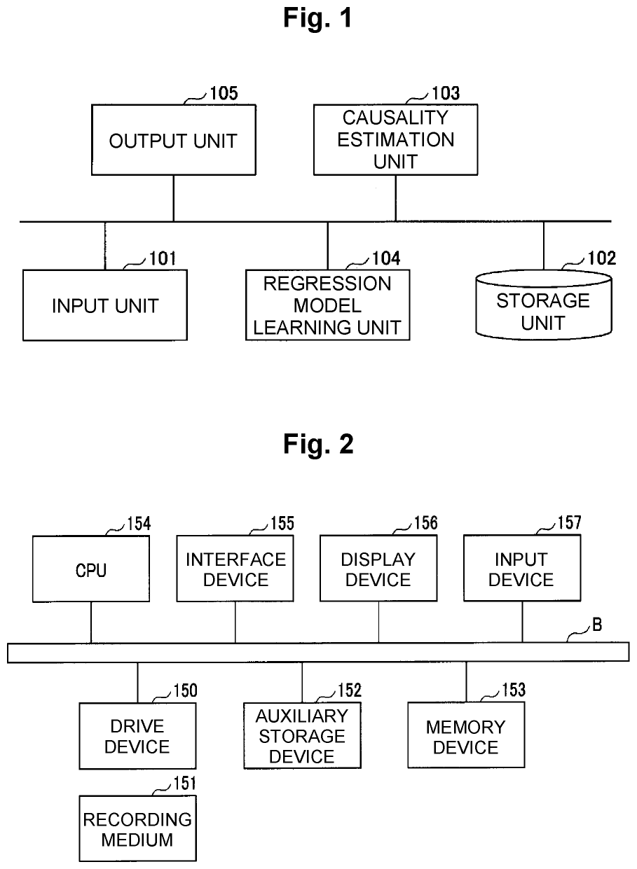

FIG. 1 illustrates an exemplary configuration of a causality estimation device 100 in the present embodiment. As illustrated in FIG. 1, the causality estimation device 100 in the present embodiment includes an input unit 101, a storage unit 102, a causality estimation unit 103, a regression model learning unit 104, and an output unit 105.

The input unit 101 receives inputting of external information such as temporally sequential multi-dimensional numerical vector data and various parameters to the causality estimation device 100. The storage unit 102 holds data, models, parameters, and the like input through the input unit 101. The causality estimation unit 103 calculates the strength of causality between dimensions. The regression model learning unit 104 learns a non-linear regression model. The output unit 105 outputs the strength of causality between dimensions, which is calculated by the causality estimation unit 103. Processing at the regression model learning unit 104 and the causality estimation unit 103 will be described in detail in Examples 1 to 6 later.

(Exemplary Hardware Configuration)

The causality estimation device 100 described above can be achieved, for example, by a computer executing a computer program in which processing contents described in the present embodiment is written.

Specifically, the causality estimation device 100 can be achieved by executing, by using hardware resources such as a CPU and a memory built in the computer, a computer program corresponding to processing performed by the causality estimation device 100. The above-described computer program may be recorded, stored, and distributed in a recording medium (such as a portable memory) readable by the computer. The above-described computer program may be provided through a network such as the Internet or electronic mail.

FIG. 2 is a diagram illustrating an exemplary hardware configuration of the above-described computer in the present embodiment. The computer in FIG. 2 includes a drive device 150, an auxiliary storage device 152, a memory device 153, a CPU 154, an interface device 155, a display device 156, an input device 157, and the like, which are connected with each other through a bus B.

The computer program that achieves processing at the computer is provided in a recording medium 151 such as a CD-ROM or a memory card. When the recording medium 151 storing the computer program is set to the drive device 150, the computer program is installed from the recording medium 151 onto the auxiliary storage device 152 through the drive device 150. However, the computer program does not necessarily need to be installed from the recording medium 151, but may be downloaded from another computer through the network. The auxiliary storage device 152 stores the installed computer program as well as necessary files, data, and the like.

When activation of the computer program is instructed, the memory device 153 reads the computer program from the auxiliary storage device 152 and stores the read computer program. The CPU 154 achieves functions of a model learning device 100 in accordance with the computer program stored in the memory device 153. The interface device 155 is used as an interface for connection with the network. The display device 156 displays a graphical user interface (GUI) and the like by the computer program. The input device 157 is configured by a keyboard, a mouse, a button, a touch panel, or the like and used to receive inputting of various operation instructions. The display device 156 may not be included.

The following describes exemplary operations of the causality estimation device 100 as Examples 1 to 6. Example 1 describes below a basic exemplary operation, and Examples 2 to 6 mainly describe differences from Example 1.

### Example 1

Example 1 describes an example in which a non-linear regression model x_t=c+f(x_t−τ, x_t−τ+1, . . . , x_t−1)+ε_t is estimated by using input temporally sequential multi-dimensional numerical vector data and the causality between dimensions is estimated by using an impulse response function of the model.

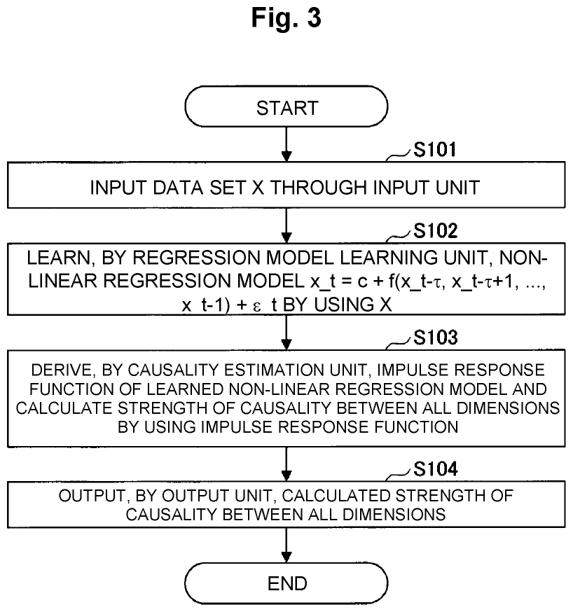

The following describes the operation of the causality estimation device 100 in Example 1 with reference to a flowchart in FIG. 3.

S101) A temporally sequential multi-dimensional numerical vector data set X={x_1, . . . , x_T} collected from a system through the input unit 101 is input. Examples of the collected data include the traffic amount on each interface, CPU and memory loads, and the number of times of templated syslog ID appearance at each time.

S102) The regression model learning unit 104 learns the non-linear regression model x_t=c+f(x_t−τ, x_t−τ+1, . . . , x_t−1)+ε_t (where c represents a constant term, f represents an optional non-linear function, and ε_t represents an error term at time t) by using the input X. The model function z=f(y) may be an optional model such as a power model z=a*y\hat{ }b or an exponential model z=a*b\hat{ }y. The learning method may be an optional method such as regression using a least-square method (Bohme, J. “Estimation of source parameters by maximum likelihood and nonlinear regression.” Acoustics, Speech, and Signal Processing, IEEE International Conference on ICASSP'84. Vol. 9. IEEE, 1984). As for the selection of the model and the learning method, they may be preset and stored in the storage unit 102 in advance, or may be selected based on inputting through the input unit 101. S103) The causality estimation unit 103 calculates an impulse response function of the non-linear regression model based on the learned model. The impulse response function indicates the degree of influence of shock provided to the dimension j of data at time t-p on the dimension i of data at time t, and is defined by the partial differential ∂x_{t,i}/∂ε_{t−p,j} of x_{t,i} with respect to ε_{t−p,j} (indicating the influence of variation in the error term of the dimension j time p before on the dimension i). Although discussion of a typical impulse response function is provided in Non-Patent Literature 5, the following describes, for simplification, a case in which the model function f is differentiable with respect to optional y and the error term ε_t is independent among dimensions. The impulse response function for optional p can be recursively calculated as described below.

First, when a data set of x_t−τ, x_t−τ+1, . . . , x_t−1 is provided, the impulse response function of the dimension i time p after for shock of the dimension j is defined as IRF_{i,j}(p, x_t−τ, x_t−τ+1, . . . , x_t−1). This is because, for p>0 as described later, the impulse response function depends on the data x_t−τ, x_t−τ+1, . . . , x_t−1. By definition, the impulse response function for p=0 is provided to be constant:

$${IRF}_{i , j} ( 0 , {x}_{t - τ} , … , {x}_{t - 1} ) = \frac{\partial {x}_{t , i}}{\partial {ϵ}_{t , j}} = \{ \begin{matrix}1 & If i = j \\ 0 & Else\end{matrix} \qquad [ Formula 1 ]$$

The impulse response function for p=1 is given by:

$$\begin{matrix}IR {F}_{i , j} ( 1 , {x}_{t - τ} , … , {x}_{t - 1} ) = \frac{\partial {x}_{t , i}}{\partial {ϵ}_{t - 1 , j}} \\ = {\sum }_{k = 1}^{N} \frac{\partial {x}_{t - 1 , k}}{\partial {ϵ}_{t - 1 , j}} \frac{\partial {f}_{i} ( {x}_{t - τ} , … , {x}_{t - 1} )}{\partial {x}_{t - 1 , k}} \\ = IR {F}_{i , j} ( 0 ) \frac{\partial {f}_{i} ( {x}_{t - τ} , … , {x}_{t - 1} )}{\partial {x}_{t - 1 , j}} \\ = \frac{\partial {f}_{i} ( {x}_{t - τ} , … , {x}_{t - 1} )}{\partial {x}_{t - 1 , j}}\end{matrix} \qquad [ Formula 2 ]$$

based on the chain rule of differentiation and the above expression. In the expression, f_i(⋅) is a function that provides the value of the dimension i in f(⋅). The impulse response function for p=2 is given by:

$$I R {F}_{i , j} ( 2 , {x}_{t - τ} , … , {x}_{t - 1} ) = \frac{\partial {x}_{t , i}}{\partial {ϵ}_{t - 2 , j}} = {\sum }_{{k}_{1} = 1}^{N} \frac{\partial {x}_{t - 1 , {k}_{1}}}{\partial {ϵ}_{t - 2 , j}} \frac{\partial {f}_{i} ( {x}_{t - τ} , … , {x}_{t - 1} )}{\partial {x}_{t - 1 , {k}_{1}}} + {\sum }_{{k}_{0} = 1}^{N} \frac{\partial {x}_{t - 2 , {k}_{0}}}{\partial {ϵ}_{t - 2 , j}} \frac{\partial {f}_{i} ( {x}_{t - τ} , … , {x}_{t - 1} )}{\partial {x}_{t - 2 , {k}_{0}}} = {\sum }_{{k}_{1} = 1}^{N} {IRF}_{{k}_{1} , j} ( 1 , {x}_{t - τ} , … , {x}_{t - 1} ) \frac{\partial {f}_{i} ( {x}_{t - τ} , … , {x}_{t - 1} )}{\partial {x}_{t - 1 , {k}_{1}}} + {\sum }_{{k}_{0} = 1}^{N} \frac{\partial {f}_{i} ( {x}_{t - τ} , … , {x}_{t - 1} )}{\partial {x}_{t - 2 , {k}_{0}}} \qquad [ Formula 3 ]$$

and thus IRF_{i,j}(p, x_t−τ, x_t−τ+1, x_t−1) can be generalized as:

$${IRF}_{i , j} ( p , {x}_{t - τ} , … , {x}_{t - 1} ) = {\sum }_{q = 1}^{p} ( {\sum }_{{k}_{q} = 1}^{N} {IRF}_{{k}_{q} , j} ( p - q , {x}_{t - τ} , … , {x}_{t - 1} ) \frac{\partial {f}_{i} ( {x}_{t - τ} , … , {x}_{t - 1} )}{\partial {x}_{t - q , {k}_{q}}} ) \qquad [ Formula 4 ]$$

The above expression depends on x_t−τ, x_t−τ+1, x_t−1, and thus similarly to discussion in Non-Patent Literature 5, an expectation value can be calculated to obtain the impulse response function IRF_{i,j}(p) of the dimension i time p after for shock of the dimension j as:

IRF_{i,j}(p)=E[IRF_{i,j}(p,x_{t-τ}, . . . ,xₜ₋₁)] [Formula 5]

In the expression, E[⋅] represents the expectation value of “⋅”. The expectation value can be calculated by performing numerical integration based on prior distribution of x_t or by averaging Expression 6 below over the collected data set X:

IRF_{i,j}(p,x_{t-τ}, . . . ,xₜ₋₁) [Formula 6]

The IRF calculation requires the differential of the regression model:

$$\frac{\partial {f}_{i} ( {x}_{t - τ} , … , {x}_{t - 1} )}{\partial {x}_{t - q , j}} \qquad [ Formula 7 ]$$

The differentiation may be achieved by storing a differential equation corresponding to each model in the storage unit 102 in advance, by inputting a differential equation together with model inputting through the input unit 101, or by numerically calculating a differential equation.

The causality estimation unit 103 calculates the strength of causality of the dimension i due to the dimension j based on the calculated impulse response function IRF_{i,j}(0), . . . , IRF_{i,j}(p_max). The value p_max may be provided by storing a predetermined value in the storage unit 102 or may be provided through the input unit 101. The calculation may be performed by various methods, for example, by simply using one of IRF_{i,j}(0), . . . , IRF_{i,j}(p_max), by calculating the sum, by calculating a weighted average, or by employing a value, the absolute value of which is maximum.

S104) The causality estimation unit 103 calculates the strength of causality for all combinations of dimensions, and the output unit 105 outputs an N×N matrix in which an element on the i-th row and the j-th column represents the strength of causality of the dimension i due to the dimension j when N represents the number of dimensions.

### Example 2

In Example 2, the overall process of the operation of the causality estimation device 100 is same as that of the process illustrated in FIG. 3 and described in Example 1, but the method of causality strength calculation at S103 is different from that in Example 1.

In Example 2, the causality estimation unit 103 calculates the strength of causality not based on the impulse response function as in Example 1 but based on change in a prediction value of the dimension i when a minute amount is provided to the dimension j. When DIFF_{i,j}(p, x_t−τ, x_t−τ+1, . . . , x_t−1) represents the error between the prediction value of the dimension i at time t when a minute amount Δ is provided to the dimension j at time t−p and the prediction value when no minute amount is provided, the error is given by:

$$D I F {F}_{i , j} ( p , {x}_{t - τ} , . . . , {x}_{t - 1} ) = {f}_{i} ( {x}_{1 , t - τ} , {x}_{2 , t - τ} … {x}_{j , t - p} + Δ , {x}_{n - 1 , t - 1} , {x}_{n , t - 1} ) - {f}_{i} ( {x}_{1 , t - τ} , {x}_{2 , t - τ} . . . , {x}_{n - 1 , t - 1} , {x}_{n , t - 1} ) \qquad [ Formula 8 ]$$

Similarly to the impulse response function, the error depends on x_t−τ, x_t−τ+1, x_t−1, and thus, to calculate the strength of causality, the expectation value is calculated as:

DIFF_{i,j}(p)=E[DIFF_{i,j}(p,x_{t-τ}, . . . ,xₜ₋₁)] [Formula 9]

and DIFF_{i,j} (1), . . . , DIFF_{i,j}(p_max) are used to determine the strength of causality as in Example 1, and the output unit 105 outputs the strength of causality for all combinations of dimensions.

### Example 3

In Example 3, the overall process of the operation of the causality estimation device 100 is same as that of the process illustrated in FIG. 3 and described in Example 1, but the method of causality strength calculation at S103 is different from that in Example 1.

The causality estimation unit 103 in Example 3 calculates the strength of causality not by using the impulse response function but by a method to be described below.

The causality estimation unit 103 only extracts terms {a_1 g_1 (x_t−τ, x_t−τ+1, x_t−1), . . . , a_M g_M(x_t−τ, x_t−τ+1, . . . , x_t−1)} (a_m represents a constant, and g_m represents a function) including x_{t−p,j} in f_i(x_t−τ, x_t−τ+1, . . . , x_t−1) and determines the strength of causality of the dimension i due to the dimension j by using the constant a_m and the order of x_{t−p,j} in the function g_m.

For example, f represents a power model, and a term including x_{t−p,j} in f_i(x_t−τ, x_t−τ+1, . . . , x_t−1) is provided as a*x_{t−p,j}\hat{ }b*g(x_t−τ, x_t−τ+1, . . . , x_t−1). The function g is a function of a variable other than x_{t−p,i}. The influence of the value of the dimension j on the dimension i time p after is expressed by using the constants a and b and the function g.

For example, the strength of influence may be simply the coefficient a or may be provided in the form of a product such as a*b. The function g(x_t−τ, x_t−τ+1, . . . , x_t−1) depends on variables x_t−τ, x_t−τ+1, . . . , x_t−1, and similarly to Examples 1 and 2, the expectation value thereof may be calculated and multiplied with a and b. Such calculation is performed for p=1, . . . , p_max, and the strength of causality is determined by using the resulting values in a manner same as that in Example 1.

### Example 4

In Example 4, the overall process of the operation of the causality estimation device 100 is same as that of the process illustrated in FIG. 3 and described in Example 1, but the method of learning at S102 is different from that in Example 1. Example 4 is also applicable to Examples 2 and 3.

In Example 4, when performing non-linear regression, the regression model learning unit 104 performs learning with a sparse term L(x_t−τ, x_t−τ+1, . . . , x_t−1) taken into account to perform sparse modeling. This prevents false estimation of the existence of causality that does not exist in reality or overlook of causality that exists as a result of false parameter estimation due to overlearning of the non-linear regression.

Examples of the method of learning with the sparse term taken into account, which is executed by the regression model learning unit 104, include the method of performing minimization involving addition of an L2 norm term λL_2(x_t−τ, x_t−τ+1, . . . , x_t−1)=λΣ_{i=1}\hat{ }τ∥x_{t−i}∥\hat{ }2 as a penalty term to an objective function in regression using a least-square method (X is a constant provided in advance or input through the input unit 101), and the method of solving minimization involving addition of an L1 norm term λL_1 (x_t−τ, x_t−τ+1, . . . , x_t−1)=λΣ_{i=1}\hat{ }τ∥x_{t−i}∥\hat{ }1 by using a proximal gradient method (Beck, Amir, and Marc Teboulle. “A fast iterative shrinkage-thresholding algorithm for linear inverse problems.” SIAM journal on imaging sciences 2.1 (2009): 183-202).

### Example 5

In Example 5, the overall process of the operation of the causality estimation device 100 is same as that of the process illustrated in FIG. 3 and described in Example 1, but the method of learning at S102 and the like are different from those in Example 1. Example 5 is also applicable to Examples 2 to 4.

In Example 5, the regression model learning unit 104 performs non-linear regression by using a neural network. The neural network has advantage of achieving various kinds of non-linear regression with simple modeling, and advantage of easily calculating the differential term needed in Example 1 by using the chain rule.

When the non-linear regression x_t=c+f(x_t−τ, x_t−τ+1, . . . , x_t−1)+ε_t is to be performed by using a neural network, the neural network is designed to include an input layer of τ×N dimension nodes to which x_t−τ, x_t−τ+1, . . . , x_t−1 are input, and an output layer of N dimension nodes from which x_t is output, and parameters of the neural network are acquired through learning by using the data set X and stored in the storage unit 102.

The number of intermediate layers and the number of dimensions in the neural network, an activation function, and learning parameters (such as a batch size and the number of learning epochs) may be determined and stored in the storage unit 102 in advance or may be provided and specified through the input unit 101.

The differential of x_{t,i}=f_i(x_t−τ, x_t−τ+1, . . . , x_t−1) with respect to x_{t−p,j}:

$$\frac{\partial {f}_{i} ( {x}_{t - τ} , … , {x}_{t - 1} )}{\partial {x}_{t - q , j}} \qquad [ Formula 10 ]$$

which is needed at S103 in Example 1, can be calculated by a back-propagation method (Goh, A. T. C. “Back-propagation neural networks for modeling complex systems.” Artificial Intelligence in Engineering 9.3 (1995): 143-151). Once the differential is calculated by the back-propagation method in this manner, the impulse response function and the strength of causality of the dimension i due to the dimension j are calculated similarly to S103 in Example 1.

When the amount of the differential calculation would become large due to a large number of dimensions or the like, the strength of causality may be calculated only by using coefficients in place of the differential calculation as in Example 3. For example, the strength of causality of the dimension i due to the dimension j time p before may be calculated by summing the product of weights on a link connecting x_{t−p,j} of the input layer and x_{t,i} of the output layer over all paths.

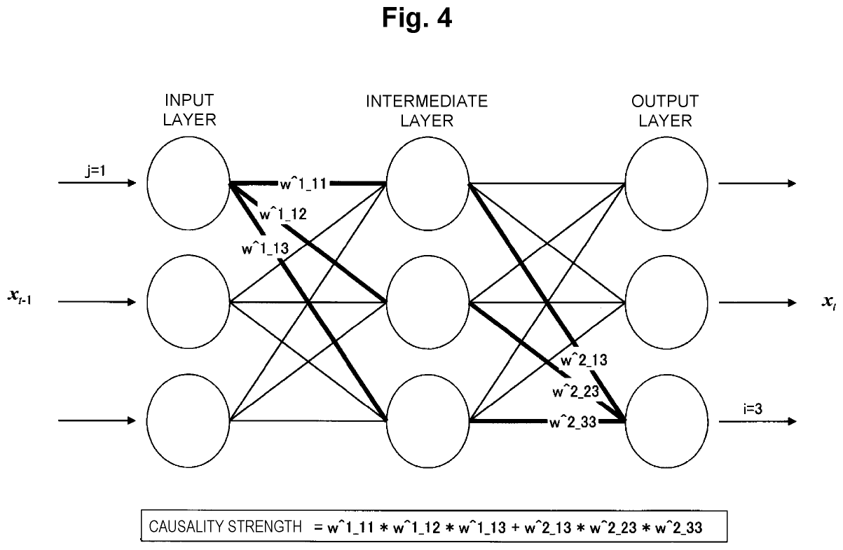

FIG. 4 illustrates an example in which, in a three-layer neural network including an input layer, an intermediate layer, and an output layer, the strength of causality of the dimension i=3 due to the dimension j=1 time p=1 before is calculated to be w\hat{ }1_11*w\hat{ }1_12*w\hat{ }1_13+w\hat{ }2_13*w\hat{ }2_23*w\hat{ }2_33, which is obtained by summing the product of weights on a link connecting x_{t−1,1} of the input layer and x_{t,3} of the output layer for all paths.

### Example 6

Processing in Example 6 is same as that of each of Examples 1, 2, and 3 except for the method of regression model calculation at S102 and the method of causality strength calculation at S103.

In Example 6, the causality estimation unit 103 calculates the strength of causality in Examples 1, 2, and 3 with taken into account importance of each parameter of the non-linear regression model. The importance indicates the strength of contribution of each parameter to non-linear regression based on an assumption that a parameter with stronger contribution is more important in causality strength estimation. In a method, for example, Fisher information amount (Jauffret, Claude. “Observability and Fisher information matrix in nonlinear regression.” IEEE Transactions on Aerospace and Electronic Systems 43.2 (2007)) for model data is used as the importance of a parameter.

In Example 6, at regression model calculation, the regression model learning unit 104 also calculates the importance F_1, . . . , F_K of parameters θ_1, . . . , θ_K and stores the calculated importance in the storage unit 102.

The causality estimation unit 103 performs the causality strength calculation in Examples 1, 2, and 3 by considering the importance of each parameter. This causality strength calculation when performed by the method described in each of Examples 1 to 3 by using the non-linear regression model may be performed by, for example, the method of simply regarding, as a new parameter θ′_k, the value θ_k*F_k obtained by multiplying the value θ_k of a parameter in the non-linear regression model by the importance F_k, or the method of providing a threshold to the importance and regarding θ_k=0 when F_k is less than the threshold.

(Effects)

With the technology of the present invention described by using the examples, it is possible to quantitatively evaluate a non-linear causality relation between dimensions by using temporally sequential multivariate data obtained from a system.

To explain effects, the following describes exemplary results of causality estimation using the impulse response function in a non-linear regression model for which sparse learning was performed by using a neural network in combination of Examples 1, 4, and 5.

In this example, data related to N syslog-id appearance x_i, where i=1, . . . , N, provided with a causality relation as described below with a lag τ=1 was generated by simulation, and causality estimation was performed by the causality estimation device 100.

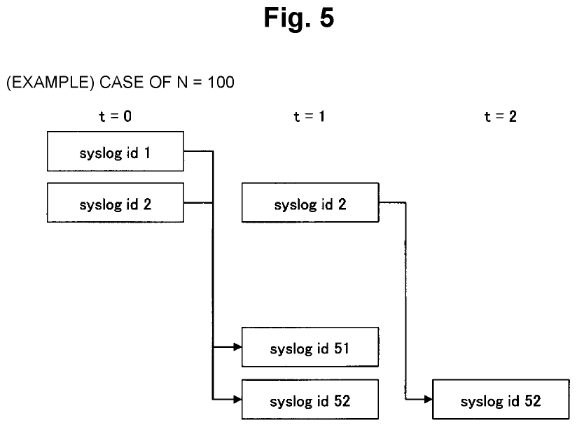

FIG. 5 illustrates an image of causality provided to the data. In this example, at each time t, the probability of appearance is determined by Bernoulli distribution, which depends on appearance one time before as described later, for syslog with id of i=1, . . . , N/2 (for example, syslog id=1 and 2 in FIG. 5), and appearance is determined depending on the syslog appearance one time before at i=1, . . . , N/2 for syslog with id of i=N/2+1, . . . , N (for example, syslog id=51 and 52 in FIG. 5). The following more specifically describes the rule of the syslog appearance at each time.

For all values of i (i<N/2), q_{i,t+1} is determined by Bernoulli distribution with probability q_cont in a case of x_{i,t}=1, and q_{i,t+1} is determined by Bernoulli distribution with probability q_i in a case of x_{i,t}=0. In this example, q_cont is 0.7, and q_i is 0.5 for i %2=1 or 0.01 for i %2=0. For all values of i (i %2=1 and i<N/2), x_{i+N/2,t+1}=1 holds for x_{i,t}=1 and x_{i+1,t}=1, and x_{i+N/2+1,t+1}=1 holds for x_{i,t}=1 or x_{i+1,t}=1. Specifically, the causality relation of i→i+N/2, i→i+N/2+1, i+1→i+N/2, and i+1→i+N/2+1 (i<N/2) exists. In the example illustrated in FIG. 5, the causality relation of 1→51, 1→52, 2→51, and 2→52 is indicated. The observation data X was x_t where t=1, . . . , T, and the above-described causality relation was estimated by the causality estimation device 100.

The causality estimation was evaluated for a data acquisition duration T of 1000, 10000, and 100000. The durations 1000, 10000, and 100000 approximately correspond to data amounts for 16 hours, one week, a little over two months, respectively, when data acquisition is performed at each minute.

In the causality estimation evaluation, the existence of causality of the first data x_l due to the k-th data x k was determined based on a threshold provided to IRF_{l,k}(1) calculated by using Example 1 in a non-linear regression model (τ=1) learned with a neural network by using Example 5, and PR-AUC was compared between different values of the threshold. The PR-AUC is the area of a region below a PR curve plotted as the threshold is changed when the vertical axis represents change of precision (the ratio of pairs between which causality actually exists among pairs between which causality is determined to exist), which is determined depending on the threshold, and the horizontal axis represents change of recall (the ratio of pairs between which causality is determined to exist among pairs between which causality actually exists), and higher PR-AUC means higher estimation accuracy.

The comparison target was the IRF when linear VAR is used as a regression model (Non-Patent Literature 4 in the conventional technology). In addition, for a neural network model, sigmoid was provided as an activation function and X was provided as weight attenuation, and learning with addition of the L2 norm term in Example 4 was performed to obtained sparse parameters. As comparison target models, a model (DNN) in which the number of intermediate layers was one and the number of dimensions was rh times larger than an input dimension, and a model (2-layer NN; corresponds to the linear VAR with the L2 norm) including only an input layer and an output layer were compared.

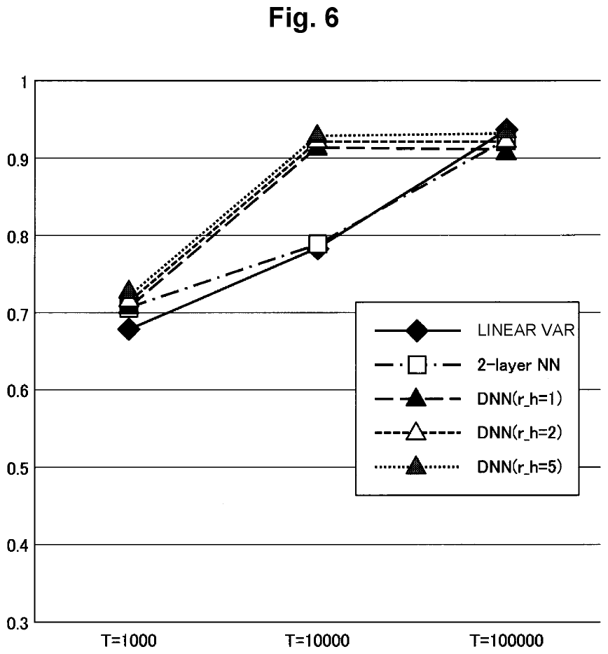

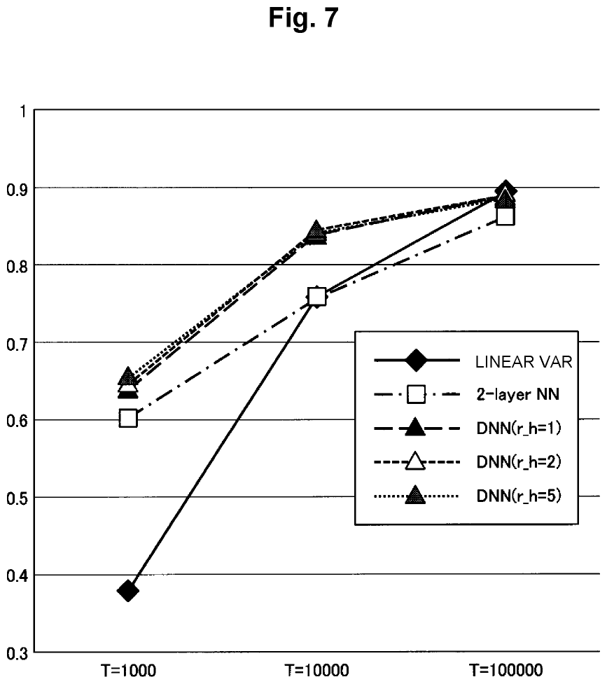

FIG. 6 illustrates a result when the number N of data dimensions was 100, and FIG. 7 illustrates a result when the number N was 500. The horizontal axis represents the data acquisition duration, and the evaluation was performed for the three patterns of T=1000, T=10000, and T=100000. The vertical axis represents the PR-AUC, and higher PR-AUC means higher accuracy of causality estimation. The coefficient λ of the L2 norm term was 10\hat{ }−4 for N=100, and 10\hat{ }−5 for N=500. As illustrated in FIGS. 6 and 7, the causality estimation by using the non-linear neural network provided with the intermediate layer was highly accurately performed in a shorter data acquisition duration than that for the linear VAR and the two-layer neural network, which confirms that non-linear causality relation was highly accurately estimated by non-linear regression.

### SUMMARY OF EXAMPLES

As described above, in Example 1, when system monitoring data is expressed as an N-dimensional temporally sequential multi-dimensional numerical vector, the data at time t is x_t=(x_{t,1}, . . . , x_{t,N}). The causality estimation device 100 learns the non-linear regression model x_t=c+f(x_t−τ, x_t−τ+1, . . . , x_t−1)+ε_t (where c represents constant term, f represents an optional non-linear function, and ε_t represents an error term at time t) in which data at time t is expressed with data at time t−τ to time t−1 by using the collected data set X={x_1, . . . , x_t}, and calculates the strength of causality of the dimension i due to the dimension j in the monitoring data by using the influence ∂x_{t,i}/∂ε_{t−p,j} (p=1, . . . , p_max) of variation in the error term of the dimension j time p before on the dimension i.

In Example 2, instead of calculating the strength of causality of the dimension i due to the dimension j in the monitoring data by using partial differential, the causality estimation device 100 calculates the strength of causality by using the change amount x′_{t,i}−x_{t,i} (x′_{t,i} represents the prediction value of the dimension i when the minute amount Δ is provided to the dimension j time p before, x_{t,i} represents the prediction value when the minute amount Δ is not provided, and p is 1, . . . , p_max) of the prediction value of the dimension i when the minute amount Δ is provided to the dimension j time p before in Example 1.

In Example 3, instead of calculating the strength of causality of the dimension i due to the dimension j in the monitoring data by using partial differential, the causality estimation device 100 focuses only on the term {a_1 g_1 (x_t−τ, x_t−τ+1, . . . , x_t−1), . . . , a_M g_M(x_t−τ, x_t−τ+1, . . . , x_t−1)} (a_m represents a constant, and g_m represents a function) including x_{t−p,j} in f_i(x_t−τ, x_t−τ+1, . . . , x_t−1) and calculates the strength of causality by using the constant a_m and the function g_m in Example 1.

In Example 4, when performing the non-linear regression in Example 1, the causality estimation device 100 performs learning with taken into account the sparse term L(x_t−τ, x_t−τ+1, . . . , x_t−1) to perform sparse modeling.

In Example 5, the causality estimation device 100 performs the non-linear regression by using a neural network in Example 1.

In Example 6, the causality estimation device 100 defines the importance F_1, . . . , F_K of the parameters θ_1, . . . , θ_K in the learned non-linear regression model and performs the causality strength calculation with the parameter importance taken into account in Example 1, 2, or 3.

As described above, according to an embodiment of the present invention, a causality estimation device including units described below is provided. The units are an input unit configured to input data of a temporally sequential multi-dimensional numerical vector; a regression model learning unit configured to learn a non-linear regression model with which data at a time is predicted from data at a past time by using the input data of the temporally sequential multi-dimensional numerical vector; a causality estimation unit configured to calculate the strength of causality of a dimension i due to a dimension j in the data of the temporally sequential multi-dimensional numerical vector by using the non-linear regression model; and an output unit configured to output the strength of the causality calculated by the causality estimation unit.

For example, the causality estimation unit calculates the strength of the causality by using influence of variation in an error term of the dimension j at time t−p on the dimension i at time t in the non-linear regression model, calculates the strength of the causality by using an error between a prediction value of the dimension i at time t based on the non-linear regression model when a minute amount Δ is provided to the dimension j at time t−p and a prediction value of the dimension i at time t based on the non-linear regression model when the minute amount is not provided, or calculates the strength of the causality by using a term including a value of the dimension j at time t−p for a prediction value of the dimension i based on the non-linear regression model.

The regression model learning unit may learn the non-linear regression model by sparse modeling with a sparse term taken into account.

The regression model learning unit may learn the non-linear regression model by using a neural network.

The regression model learning unit may calculate importance of each parameter of the non-linear regression model at calculation of the non-linear regression model, and the causality estimation unit may calculate the strength of the causality by using the importance.

In addition, according to the embodiment of the present invention, a causality estimation method executed by a causality estimation device and including steps described below is provided. The steps are an inputting step of inputting data of a temporally sequential multi-dimensional numerical vector; a regression model learning step of learning a non-linear regression model with which data at a time is predicted from data at a past time by using the input data of the temporally sequential multi-dimensional numerical vector; a causality estimating step of calculating the strength of causality of a dimension i due to a dimension j in the data of the temporally sequential multi-dimensional numerical vector by using the non-linear regression model; and an outputting step of outputting the strength of the causality calculated by the causality estimating step.

In addition, according to the embodiment of the present invention, a computer program configured to cause a computer to function as each unit of the above-described causality estimation device is provided.

Although the present embodiment is described above, the present invention is not limited to such a particular embodiment but may be modified and changed in various kinds of manners within the scope of the present invention recited in the claims.

### REFERENCE SIGNS LIST

100 causality estimation device
101 input unit
102 storage unit
103 causality estimation unit
104 regression model learning unit
105 output unit
150 drive device
151 recording medium
152 auxiliary storage device
153 memory device
154 CPU
155 interface device
156 display device
157 input device

1. A causation estimation apparatus comprising:
an input unit configured to input data of a temporally sequential multi-dimensional numerical vector;
a regression model learning unit configured to learn a non-linear regression model with which data at a time is predicted from data at a past time by using the input data of the temporally sequential multi-dimensional numerical vector;
a causality estimation unit configured to calculate a strength of causality of a dimension i due to a dimension j in the data of the temporally sequential multi-dimensional numerical vector by using the non-linear regression model; and
an output unit configured to output the strength of the causality calculated by the causality estimation unit.

2. The causation estimation apparatus according to claim 1, wherein the causality estimation unit is configured to calculate the strength of the causality by using influence of variation in an error term of the dimension j at time t−p on the dimension i at time t in the non-linear regression model, calculate the strength of the causality by using an error between a prediction value of the dimension i at time t based on the non-linear regression model based on a minute amount Δ being provided to the dimension j at time t-p and a prediction value of the dimension i at time t according to the non-linear regression model based on the minute amount not being provided, or calculate the strength of the causality by using a term including a value of the dimension j at time t−p for a prediction value of the dimension i based on the non-linear regression model.

3. The causation estimation apparatus according to claim 1, wherein the regression model learning unit is configured to learn the non-linear regression model by sparse modeling with a sparse term taken into account.

4. The causation estimation apparatus according to claim 1, wherein the regression model learning unit is configured to learn the non-linear regression model by using a neural network.

5. The causation estimation apparatus according to claim 1, wherein the regression model learning unit is configured to calculate importance of each parameter of the non-linear regression model at calculation of the non-linear regression model, and the causality estimation unit is configured to calculate the strength of the causality by using the importance.

6. A causation estimation method executed by a causation estimation apparatus, the causation estimation method comprising:
inputting data of data of a temporally sequential multi-dimensional numerical vector;
learning a non-linear regression model with which data at a time is predicted from data at a past time by using the input data of the temporally sequential multi-dimensional numerical vector;
calculating a strength of causality of a dimension i due to a dimension j in the data of the temporally sequential multi-dimensional numerical vector by using the non-linear regression model; and
outputting the calculated strength of the causality.

7. A recording medium storing a computer program, wherein
execution of the computer program causes one or more computers to perform operations comprising:
inputting data of a temporally sequential multi-dimensional numerical vector;
learning a non-linear regression model with which data at a time is predicted from data at a past time by using the input data of the temporally sequential multi-dimensional numerical vector;
calculating a strength of causality of a dimension i due to a dimension j in the data of the temporally sequential multi-dimensional numerical vector by using the non-linear regression model; and
outputting the strength of the calculated causality.

8. The recording medium according to claim 7, wherein the operations further comprise:
calculating the strength of the causality by using influence of variation in an error term of the dimension j at time t−p on the dimension i at time tin the non-linear regression model;
calculating the strength of the causality by using an error between a prediction value of the dimension i at time t based on the non-linear regression model based on a minute amount Δ being provided to the dimension j at time t−p and a prediction value of the dimension i at time t according to the non-linear regression model based on the minute amount not being provided; and
calculating the strength of the causality by using a term including a value of the dimension j at time t−p for a prediction value of the dimension i based on the non-linear regression model.

9. The recording medium according to claim 7, wherein the operations further comprise learning the non-linear regression model by sparse modeling with a sparse term taken into account.

10. The recording medium according to claim 7, wherein the operations further comprise learning the non-linear regression model by using a neural network.

11. The recording medium according to claim 7, wherein the operations further comprise:
calculating importance of each parameter of the non-linear regression model at calculation of the non-linear regression model; and
calculating the strength of the causality by using the importance.
